(19) United States
(12) Patent Application Publication
(10) Pub. No.: US 2009/0072080 A1
(43) Pub. Date: Mar. 19, 2009

(54) ON BOARD SECONDARY PROPULSION SYSTEM FOR AN AIRCRAFT

(76) Inventor: BRIJ B. BHARGAVA, SANTA BARBARA, CA (US)

Correspondence Address: THE LAW OFFICE OF RICHARD S ERBE, P.O. BOX 418, 5380 SENECA PLACE, SIMI VALLEY, CA, 93062, US

(21) Appl. No.: 12/137,789

(22) Filed: Jun. 12, 2008

Related U.S. Application Data
(63) Continuation-in-part of application No. 11/683,711, filed on Mar. 8, 2007.

(51) Int. Cl. B64D 41/00

(52) U.S. Cl. 244/58

(57) ABSTRACT

An on board secondary propulsion system for an aircraft provides the capability of taxiing the aircraft on the ground without using the main aircraft engine(s). The power system includes a small driver mounted on the aircraft. In one embodiment of the invention, the driver may be mounted at any desirable location on the aircraft and is designed to provide sufficient thrust to taxi the aircraft. Such a suitable system may be provided as original equipment to an aircraft or retrofitted to existing aircraft. In a further embodiment of the invention, the on board secondary propulsion system, in addition to the taxiing function, may be incorporated with an alternator to provide electrical power, an environmental control unit, and an emergency power unit as desired. The system may also be used to supplement the main aircraft engines as necessary during takeoff and climb to further reduce fuel consumption, noise, engine emissions, maintenance costs and extend the life of the main aircraft engines. Additionally the thrust provided by the secondary propulsion system could essentially reduce the required takeoff distance of an aircraft, thus allowing the use of shorter runways.

### RELATED APPLICATIONS

This application is a Continuation-in-Part application of patent application Ser. No. 11/683,711, filed Mar. 8, 2007, and incorporates Disclosure Document No. 597568, entitled “Auxiliary Power System For An Aircraft,” filed Mar. 17, 2006, by reference in its entirety.

### BACKGROUND OF THE INVENTION

1. Field of the Invention

The present invention relates to the field of auxiliary or secondary power systems for aircraft and, in particular, to secondary on board propulsion system that provides the capability of taxiing an aircraft without having to start or use the main aircraft engine(s).

2. General Background and State of the Art

In modern aircraft, weight space, and costs are highly important, whether the aircraft is for commercial, private or military applications. It is known, for example, that up to 15% of the costs to operate an aircraft are typically spent while the aircraft is on the ground. Conventional power systems that provide ground services for environmental cooling, engine start, ground system check-out, and emergency power (often referred to as auxiliary power units and emergency power units), while necessary, are also considered somewhat of a burden, as they generally only add weight to the aircraft while it is in flight. Thus, a reduction in parts, weight and complexity in such systems is considered highly desirable. Reliability and maintainability of aircraft systems are also very important issues, since they impact the availability of the aircraft and overall costs.

Auxiliary power systems have been integrated in aircraft that meet the aforementioned criteria. The integration of an auxiliary power unit (APU), emergency power unit (EPU), environmental control system (ECS) and engine start system (ESS) with reduced weight and size are known and are disclosed in a number of United States patents, such as U.S. Pat. No. 4,684,081 (Cronin), U.S. Pat. No. 5,235,812 (Klaass et al.), U.S. Pat. No. 5,309,029 (Gregory et al.), U.S. Pat. No. 5,408,821 (Romero et al.), and U.S. Pat. No. 5,490,645 (Woodhouse). Such systems include the capabilities of providing power for ground check-out, ground cooling, main engine start, flight cooling, and emergency engine start.

However, all such existing on board power systems, while providing many essential functions, do not provide the capability of taxiing the aircraft on the ground between the gate, hangar, or maintenance area to the runway and back without having to use the main engine(s). Such a power system would provide distinctive advantages to the aircraft owner and an airport, such as reduced fuel consumption, lowered emissions, lower noise levels, lower maintenance, and less wear (and thus longer useful life) of the main engine(s). Until recently, the cost of fuel was not a significant factor; today, however, operators are very concerned about fuel costs, as they have risen dramatically. Similarly, emissions and noise levels, until recently, were not as great a concern as they are today. The need for such a system is especially great at busy airports where aircraft frequently spend extended times at a gate or on the tarmac with its main engine(s) running.

A secondary propulsion system according to the present invention may also be used in conjunction with the main aircraft engines during takeoff and initial climb to reduce fuel consumption, harmful emissions, noise, and maintenance costs and extend the life of the main aircraft engines.

A power system, such as the secondary propulsion system according to the present invention, that would provide the capability of taxiing an aircraft without using the main aircraft engine(s) would preferably be small in size and weight, highly reliable, low cost, require minimum changes to existing aircraft systems, may also be used for power generation during taxiing and takeoff, be readily integrated with existing aircraft systems and could make existing on board auxiliary power systems unnecessary or redundant. Such a system would also help to offset the low utilization factor problems of conventional auxiliary power and emergency power units. Additionally, such a system could provide redundancy and/or additional power to the aircraft if necessary.

Such a system is also very advantageous for short duration flights, as it provides significant fuel savings, but also provides significant advantages for flights of any duration.

It would be desirable, therefore, if a novel on board secondary propulsion system for taxiing an aircraft without having to use the main engine(s) could be provided and that could be easily retrofitted to an existing aircraft or be integrated with the systems on a new aircraft.

It would also be desirable if such a system could reduce the length of the runways required for takeoff of aircraft and reduce climb times.

Furthermore, it would be desirable if such a system could be used in conjunction with the main aircraft engines to provide secondary propulsion and supplement the thrust required during takeoff and climb to further reduce fuel consumption, noise, and harmful emissions, while extending the life of the main aircraft engines. The inventor is unaware of any such system(s) available to the aircraft industry today.

### SUMMARY OF THE INVENTION

It is therefore an object of the present invention to provide an on board secondary propulsion system that can provide the ability to taxi an aircraft without having to use the main aircraft engine(s).

A further object of the present invention to provide an on board secondary propulsion system that may be used in conjunction with the main aircraft engines during takeoff and climb.

It is yet another object of the present invention to provide an on board secondary propulsion system that can be readily retrofitted for use with existing aircraft.

It is a further object of the present invention to provide an on board secondary propulsion system that can be provided as standard equipment on new aircraft.

It is another object of the present invention to provide an on board secondary propulsion system that is small in size and light in weight.

It is a further object of the present invention to provide an on board secondary propulsion system that is high in efficiency and reliability.

Yet another object of the present invention is to provide an on board secondary propulsion system that is low in cost.

Another object of the present invention is to provide an on board secondary propulsion system that will reduce the overall fuel consumption of an aircraft.

Still another object of the present invention is to provide an on board secondary propulsion system that will require minimum changes and impacts to existing power systems on the aircraft.

It is yet another object of the present invention to provide an on board secondary propulsion system that will lower the overall level of noise emissions.

A further object of the present invention is to provide an on board secondary propulsion system that will result in lowered emissions of undesirable gases and solids to the atmosphere.

Another object of the present invention is to provide an on board secondary propulsion system that may be easily integrated with existing auxiliary power units and may make such units unnecessary and offset the low utilization factor problems of conventional auxiliary power and emergency power units.

A further object of the present invention is to provide an on board secondary propulsion system that will reduce the required length of runways needed for aircraft to takeoff.

Still another object of the present invention is to provide an on board secondary propulsion system that could provide redundancy with other aircraft systems.

It is yet another object of the present invention to provide an on board secondary propulsion system that can provide additional electrical power to the aircraft if necessary.

Another object of the present invention is to provide an on board secondary propulsion system that can assist in gliding and landing an aircraft during emergencies.

Still a further object of the present invention is to provide an on board secondary propulsion system that can reduce takeoff and climbing times.

A secondary propulsion system according to a first embodiment of the present invention includes a control system and control panel in the aircraft that provides starting power to the driver, and may also provide primary and emergency power to the aircraft. The driver in the system according to a first embodiment of the invention may be a small turbine engine. A small turbine engine may be installed on an existing aircraft at any convenient location to provide sufficient thrust to drive the aircraft for taxiing, and mounted such that it would not affect the aerodynamic performance of the aircraft. It may be mounted on a retractable system similar to that used for landing gear. Such a system is light weight, highly reliable, and could be modified and made adaptable to existing aircraft, or provided as standard equipment on new aircraft.

In a second embodiment of the invention, a driver, such as a small turbine engine, may be mounted on any convenient location on the aircraft and modified to include a high speed starter/generator on a high speed power shaft. The driver would be mounted such that it would not affect the aerodynamic performance of the aircraft. It may be mounted on a retractable system similar to that used for landing gear. The starter/generator could also be used in conjunction with a conventional environmental control unit. This embodiment of the invention could replace the conventional auxiliary aircraft power units as disclosed in Cronin, Klaass et al., Gregory et al., Romero et al., and Woodhouse, by providing all or any combinations of the same functions that those units provide. Additionally, such a system could be integrated to supplement and/or provide additional electrical power or designed to provide added redundancy if necessary.

Any of these embodiments of the on board power secondary propulsion system according to the present invention may be used in conjunction with the main aircraft engines during taxiing and takeoff that provides the benefits of reduced fuel consumption, lowered emissions, less noise, increasing the life of the main aircraft engines, and reducing maintenance costs for the aircraft.

Further objects and advantages of this invention will become more apparent from the following description of the preferred embodiment, which, taken in conjunction with the accompanying drawings, will illustrate, by way of example, the principles of the invention.

### BRIEF DESCRIPTION OF THE DRAWINGS

The foregoing and other aspects and advantages will be better understood from the following detailed description of the preferred embodiments of the invention with reference to the drawings in which:

FIG. 1A is a front view of an aircraft illustrating where an on board secondary propulsion system according to the present invention may be located;

FIG. 1B is a bottom view of an aircraft on which an on board secondary propulsion system according to the present invention may be located;

FIG. 1C is a side view of an aircraft illustrating where an on board secondary propulsion system according to the present invention may be located;

FIG. 2 is a schematic diagram illustrating a first embodiment of an on board secondary propulsion system in accordance with the present invention;

FIG. 3 is a schematic diagram illustrating a second embodiment of an on board secondary propulsion system in accordance with the present invention;

FIG. 4A illustrates a front view of an aircraft illustrating several locations where an on board secondary propulsion system according to the present invention may be located on the aircraft;

FIG. 4B illustrates a bottom view of an aircraft illustrating several locations where an on board secondary propulsion system according to the present invention may be located on the aircraft;

FIG. 4C illustrates a side view of an aircraft illustrating several locations where an on board secondary propulsion system according to the present invention may be located on the aircraft.

FIG. 5 is a block diagram illustrating the use of an on board secondary propulsion system according to the present invention to provide secondary propulsion in conjunction with the main engines during taxiing, takeoff and climb; and

FIG. 6 graphically illustrates how the combination of main engines and secondary propulsion engine may be used during taxiing, takeoff, and climb.

### DETAILED DESCRIPTION OF THE PREFERRED EMBODIMENTS OF THE INVENTION

In the following description of the invention, reference is made to the accompanying drawings, which form a part thereof, and in which are shown, by way of illustration, exemplary embodiments illustrating the principles of the secondary propulsion system of the present invention and how it may be practiced. It is to be understood that other embodiments may be utilized to practice the present invention and structural and functional changes may be made thereto without departing from the scope of the present invention.

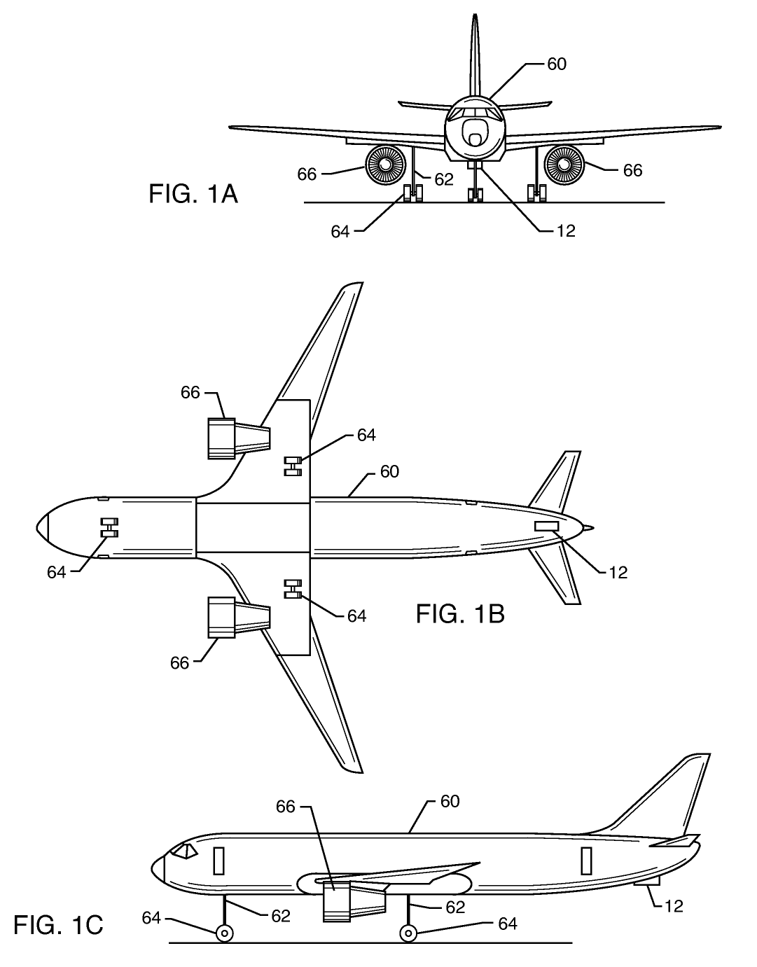

A secondary propulsion system according to the present invention is disclosed in several embodiments generally indicated by the numerals 10 and 110 and may be located on an aircraft 60 in various locations on the aircraft, as illustrated in FIGS. 1A-1C, and mounted such that it would not affect the aerodynamic performance of the aircraft. It may be mounted on a retractable system similar to that used for landing gear. A potential location is near the tail of the aircraft adjacent an existing APU. The purpose of the secondary propulsion system according to the present invention is to provide taxiing of aircraft 60 without having to operate the main aircraft engine(s) 66 and to assist the main engines during takeoff and climbing of the aircraft.

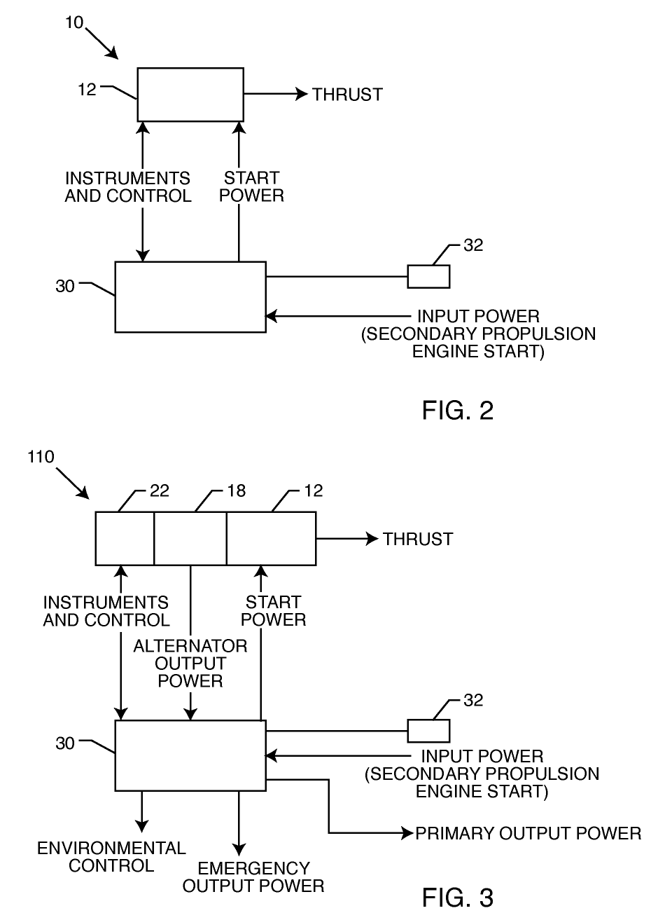

FIG. 2 schematically illustrates a first embodiment of a secondary propulsion system 10 in accordance with the present invention. System 10 includes driver 12, which may be a turbine engine, for example, which provides output power for taxiing aircraft 60 without having to start the main flight engine(s) 66 of the aircraft.

Driver 12 is in communication with control system 30, which also includes control panel 32 having the appropriate instrumentation, controls, indicator lights, and switches typical of such systems. Such control systems are well-known and quite common to those having skill in the art and the details of such a control system need not be discussed here. Also, the design of turbine engines, APU's, EPU's, ECS's, ESS's, gearboxes and engine mounting structures are also well-known and quite common to those having skill in the art and the details of such systems, equipment and structures need not be discussed here. In the first embodiment 10 of the invention, control system 30 provides starting power to driver 12. The first embodiment of power system 10 may be retrofitted to existing aircraft to provide taxiing capability. This embodiment 10 of a secondary propulsion system provides taxiing capability while being small in size and weight, highly efficient, highly reliable, low cost, low in fuel consumption, lower in emissions to the environment and low in maintenance. Such a system, retrofitted to an existing aircraft, would require minimal changes to existing aircraft systems. Such a system could also be provided as standard equipment on new aircraft.

Driver 12 may be a small turbine engine that produces sufficient power to provide taxiing capability. Such an engine is highly reliable and would add no more than 400 pounds to the aircraft weight.

FIG. 3 illustrates schematically a second embodiment 110 of the secondary propulsion system according to the principles of the present invention. Such a power system could be located at a similar location or locations on aircraft 60 as would the power system of the first embodiment of the invention.

In this second embodiment of the invention, secondary propulsion system 110 includes driver 12, which would be designed to have a high speed power shaft (not shown). A high-speed alternator 18 would be mounted on the high-speed power shaft. Alternator 18, as is well known in the art, may also act as a starter/generator. Alternator 18 may be used in conjunction with an environmental control unit 22, which provides conditioned air where required in various compartments of the aircraft.

Driver 12 is in communication with control system 30, which also includes control panel 32 having the appropriate instrumentation, controls, indicator lights, and switches typical of such systems. As has been previously discussed, such control systems are well known and quite common to those having skill in the art and the details of such a control system need not be discussed here. Also as previously discussed, the design of turbine engines, APU's, EPU's, ECS's, ESS's, gearboxes and engine mounting structures are also well-known and quite common to those having skill in the art and the details of such systems, equipment and structures need not be discussed here. In this embodiment of the invention, control system 30 provides starting power to driver 12, and subsequently, primary output power and emergency output power to aircraft 60. This alternative embodiment of the secondary propulsion system 110 may be retrofitted to existing aircraft to provide sufficient thrust power to provide taxiing capability. This embodiment of a secondary propulsion system provides taxiing capability while being small in size and weight, highly efficient, highly reliable, low in cost, low in fuel consumption, lower in emissions to the environment and low in maintenance. Such a system, retrofitted to an existing aircraft, would require minimal changes to existing aircraft systems. Such a system could also be provided as standard equipment on a new aircraft.

Driver 12 in this embodiment 110 of the invention may be a modified turbine engine with the alternator 18 being a high speed alternator, with a desired output, for example, of 30 to 120 kVA. The combination of driver 12, alternator 18, and the associated controls, would likely add less than 600 pounds of weight to the aircraft. Several types of engines exist from which a suitable one may be chosen and modified as a driver to provide a light weight, reliable, low maintenance, low fuel consumption, low noise, low cost, and low emissions system. Such a system 110 could eventually replace or render unnecessary conventional auxiliary power units, thereby further reducing the total weight and number of parts of the conventional systems in an aircraft. Additionally, such a system could be integrated to supplement and/or provide additional electrical power or designed to provide added redundancy if necessary.

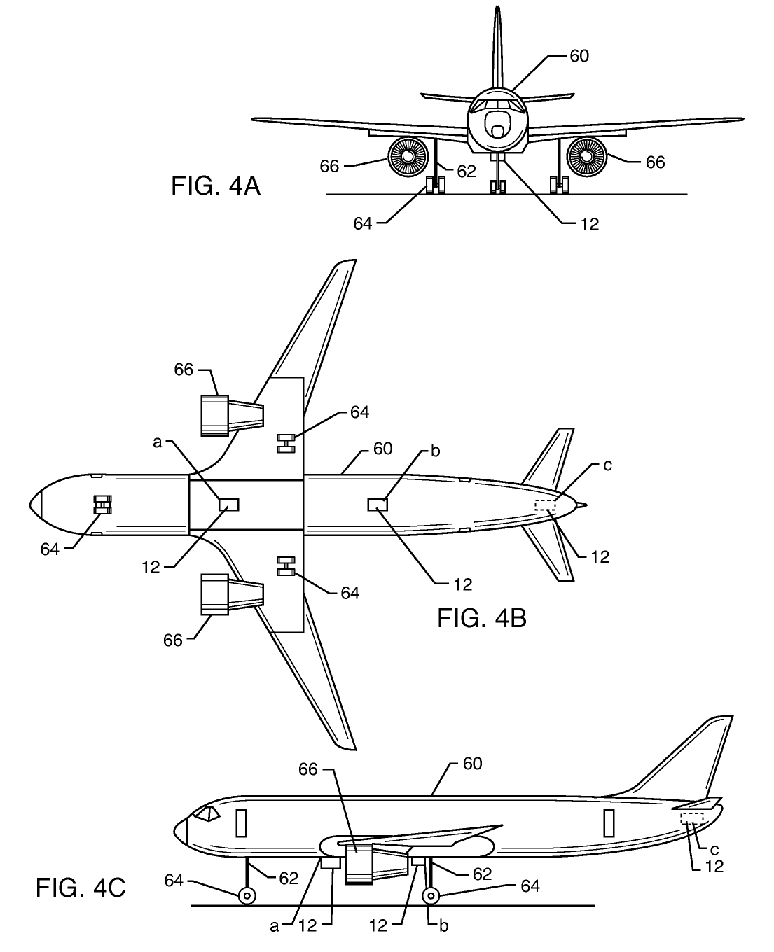

FIGS. 4A-4C illustrate that the driver 12 may be mounted on aircraft 60 at any of several convenient locations, such as locations a, b, or c, and mounted such that it would not affect the aerodynamic performance of the aircraft. It may be mounted on a retractable system similar to that used for landing gear. A desirable location would depend upon the type and design of the aircraft. The inlet, exhaust, fuel lines, instrumentation and wiring, fire wall, and other safety features have to be carefully designed and installed as required.

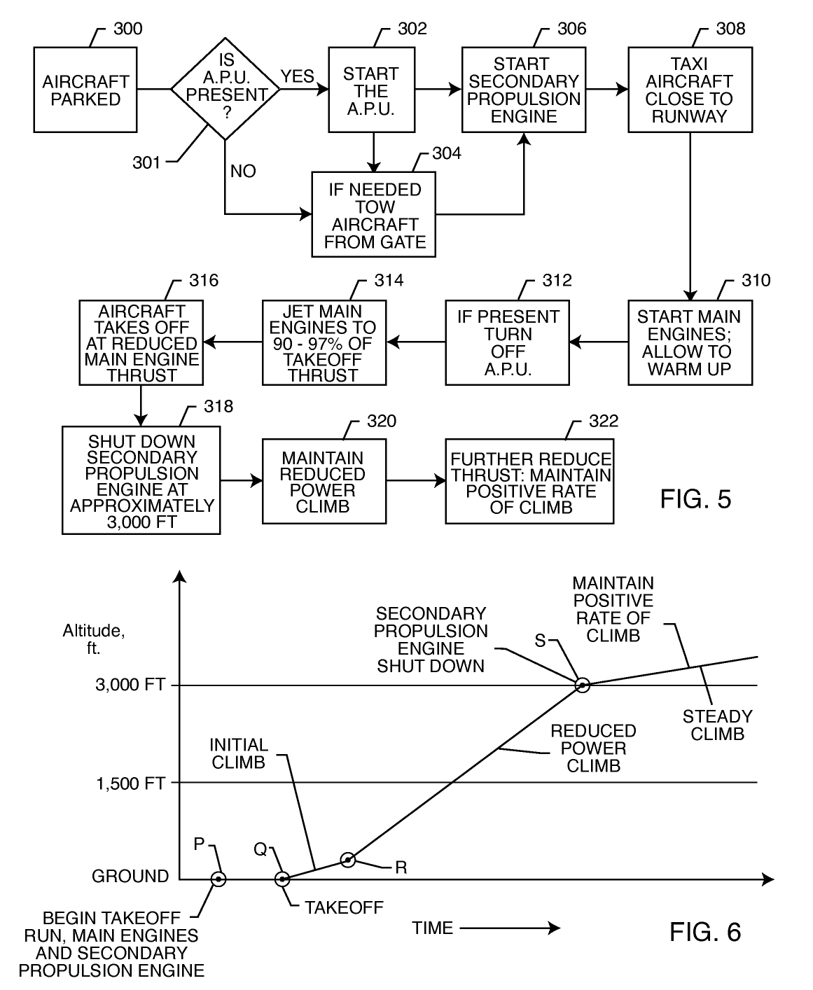

FIGS. 5 and 6 illustrate the steps of the methods by which an on board secondary propulsion system according to any of the embodiments of the invention may be used to provide secondary propulsion during taxiing, takeoff, and climb in conjunction with the main engines of the aircraft. The use of such a secondary propulsion system provides a number of distinct advantages, as will be discussed.

In the discussion that follows, several terms and phrases will be used to define particular aspects of aircraft maneuvers and performance. While these terms may be generally used in the aircraft industry, it is important to understand the context in which the terminology is being used in relation to the particular embodiments of the present invention. Taxiing, which has been used already, refers to movement of the aircraft on the ground and/or tarmac other than takeoff and landing.

At any airport or other facility where aircraft take off and land, a variety of parameters directly affect decisions relating to the level of thrust power being provided by a secondary propulsion system and the main aircraft engines. On board computer systems take into account the height of surrounding buildings and other infrastructure, topographical features, elevation, temperature, relative humidity, and other environmental factors (rain, ice, snow, etc.), aircraft load, runway length, wind direction and wind velocity, etc., to determine the optimal settings for the secondary propulsion system and the main aircraft engines. It should be understood that aircraft maneuvers such as 1) Initial Climb; 2) Reduced Power Climb; and 3) Steady Climb, all of which will be subsequently defined, will vary with these parameters and the commands sent by the on board computer systems to the aircraft systems.

As used herein, the phrase “Initial Climb” refers to the climbing movement of the aircraft from the time the aircraft wheels leave the runway to the point at which the aircraft has cleared the buildings, infrastructure, and geographical features in the area from which the aircraft has taken off. The height above runway level at which Initial Climb is completed will vary with local features and parameters described earlier. Initial Climb may be completed a few hundred feet above runway level or may require upwards of one thousand feet.

“Reduced Power Climb,” as used herein, refers to the climbing movement of the aircraft from the end of Initial Climb with the secondary propulsion system assisting the main engines, which are operating at reduced thrust until the secondary propulsion system is turned off. While the height above runway level to the start of Reduced Power Climb varies, as discussed previously, and the height above runway level at which Reduced Power Climb also varies depending on local features and other parameters, as described earlier, a good rule of thumb is that Reduced Power Climb ends at a height above the runway of about 3,000 feet.

As used herein, “Steady Climb” refers to the climbing movement of the aircraft from the point at which the secondary propulsion system is shut off and the main engines, operating at less than full thrust, are able to maintain a positive rate of climb.

Referring to FIG. 5, at block 300 the aircraft is parked, generally at the departure gate. At block 301, it is determined if the aircraft has an APU. At block 302, if there is an APU, the APU is started. At block 304, if necessary (it is standard procedure at some facilities), the aircraft is towed away from its parked location to another location. If there is no APU present, the next step is block 304, if necessary, or block 306.

At block 306, the secondary propulsion system is started. At block 308, the aircraft is taxied close to the runway using the secondary propulsion system.

At block 310, the main aircraft engines are started and allowed to warm up. At block 312, if appropriate, the APU (if present) is shut off, if it is no longer necessary.

At block 314, the main engines are set below their normal takeoff thrust, which may be 90% to 97% of their normal takeoff thrust. At block 316, the aircraft takes off using the secondary propulsion engine in conjunction with the main aircraft engines, which are running at reduced takeoff thrust and the aircraft proceeds through the step of Initial Climb.

At block 318, the aircraft climbs through Reduced Power Climb until the secondary propulsion engine is shut down. At block 320, the main aircraft engines are kept at their required reduced thrust levels through Steady Climb until, at block 322, the main aircraft engine thrust levels are further reduced to a level that still allows the aircraft a positive rate of climb.

FIG. 6 graphically illustrates the method just described. Point P is the beginning of the takeoff run, and point Q is the point of takeoff. Between points P and Q, the secondary propulsion engine is running and the main aircraft engines are running at reduced thrust, approximately 90% to 97% of maximum thrust. Between point Q and point R, the aircraft moves through its Initial Climb, until the surrounding buildings, infrastructure and topographical features are cleared. Between point R and point S, the aircraft goes through Reduced Power Climb. The main aircraft engines continue to run at their reduced thrust until point S is reached. At that point, the secondary propulsion system is shut off and the thrust of the main aircraft engines is further reduced but are still able to provide the aircraft with a positive rate of climb during Steady Climb.

The combination of secondary propulsion engines and main engines running at reduced thrust for the takeoff and climb procedure just described provides a number of advantages over the conventional use of just the main engines running at full thrust for takeoff and climb. Because the main engines are running at reduced thrust, which may be as low as 90% of maximum (the control system will optimize the setting of main engine thrust), the main engines are running at reduced temperatures, which can significantly lower the formation and emission of NOₓ and other harmful emissions. Reducing the thrust at which the main aircraft engines are running by 10%, for example, can reduce the emissions of harmful gases and particulate by as much as 30%. Noise levels are also substantially reduced.

Running the main aircraft engines at lower temperatures reduces stress on engine parts, extends main engine life (by as much as 100%) and lowers the overall cost of maintenance to an aircraft. Of course, running the main engines at less than maximum thrust also reduces the fuel consumption (by as much as 6% during takeoff and Initial Climb), thus lowering overall costs of operation, and can extend the range of the aircraft.

The foregoing description of exemplary embodiments of the present invention have been presented for purposes of enablement, illustration, and description. They are not intended to be exhaustive of or to limit the present invention to the precise forms discussed. There may be, however, other secondary propulsion systems not specifically described herein, but with which the present invention is applicable. The present invention should therefore not be seen as limited to the particular embodiments described herein; rather, it should be understood that the present invention has wide applicability with respect to the on board secondary propulsion systems for aircraft. Such other configurations can be achieved by those skilled in the art in view of the description herein. Accordingly, the scope of the invention is defined by the following claims.

What is claimed is:

1. A method of using an on board secondary propulsion system in an aircraft having one or more main engine(s) and an auxiliary power unit for aircraft operations, the method comprising the steps of:
starting the auxiliary power unit;
starting the secondary propulsion engine; and
taxiing the aircraft close to a runway for takeoff.

2. The method according to claim 1, further comprising the steps of:
starting the one or more main engine(s);
turning off the auxiliary power unit;
setting the one or more main engine(s) at less than maximum thrust for takeoff and initial climb; and
using the secondary propulsion system in conjunction with the one or more main engine(s) running at less than maximum takeoff thrust to cause the aircraft to take off and go through Initial Climb,
whereby, the consumption of fuel and the emission of harmful gases are reduced.

3. The method according to claim 2, further comprising the steps of:
using the secondary propulsion system in conjunction with the one or more main engine(s) running at less than maximum take-off thrust to cause the aircraft to complete Reduced Power Climb; and
shutting down the secondary propulsion engine when the aircraft has completed Reduced Power Climb.

4. The method according to claim 2, wherein said one or more main engine(s) run(s) at 90 to 97% of maximum takeoff thrust.

5. The method according to claim 1, wherein prior to the step of starting the auxiliary power unit, the method includes the step of:
towing the aircraft from the gate if required.

6. A method of using an on board secondary propulsion system in an aircraft having one or more main engine(s) for aircraft operations, the method comprising the steps of:
starting the secondary propulsion engine; and
taxiing the aircraft close to a runway for takeoff.

7. The method according to claim 6, further comprising the steps of:
starting the one or more main engine(s);
setting the one or more main engine(s) at less than maximum thrust for takeoff and initial climb; and
using the secondary propulsion system in conjunction with the one or more main engine(s) running at less than maximum takeoff thrust to cause the aircraft to take off and go through Initial Climb,
whereby, the consumption of fuel and the emission of harmful gases are reduced.

8. The method according to claim 7, further comprising the steps of:
using the secondary propulsion system in conjunction with the one or more main engine(s) running at less than maximum take-off thrust to cause the aircraft to complete Reduced Power Climb; and
shutting down the secondary propulsion engine when the aircraft has completed Reduced Power Climb.

9. The method according to claim 7, wherein said one or more main engine(s) at 90 to 97% run(s) of maximum takeoff thrust.

10. The method according to claim 6, wherein prior to the step of starting the secondary propulsion engine, the method includes the step of:
towing the aircraft from the gate if required.
